(19) United States
(12) Patent Application Publication
(10) Pub. No.: US 2007/0222713 A1
(43) Pub. Date: Sep. 27, 2007

(54) METHOD OF DRIVING PLASMA DISPLAY PANEL

(76) Inventor: Joo-Yul Lee, Suwon-si (KR)

Correspondence Address: CHRISTIE, PARKER & HALE, LLP, PO BOX 7068, PASADENA, CA, 91109-7068, US

(21) Appl. No.: 11/679,772

(22) Filed: Feb. 27, 2007

(30) Foreign Application Priority Data
Feb. 28, 2006 (KR) 10-2006-0019293

(51) Int. Cl. G09G 3/28

(52) U.S. Cl. 345/63

(57) ABSTRACT

A method of driving a plasma display panel that reduces the intensity of a light unit and performs a stable address discharge. Each frame includes a plurality of subfields. A sustain discharge is performed according to a grayscale weight allocated to each subfield. A first subfield having a lowest grayscale weight is divided into a reset period in which all discharge cells are initialized, and an address period in which discharge cells that are to be turned on are selected. A second subfield subsequent to the first subfield is divided into a reset period, an address period, and a sustain period in which a sustain discharge is performed according to a grayscale weight in the selected discharge cells. A low voltage level of a scan pulse applied to scan electrodes in the address periods is lower than a low voltage level of a sustain pulse applied in the sustain period.

### CROSS-REFERENCE TO RELATED PATENT APPLICATIONS

This application claims priority to and the benefit of Korean Patent Application No. 10-2006-0019293, filed on Feb. 28, 2006, in the Korean Intellectual Property Office, the entire content of which is incorporated herein by reference.

### BACKGROUND OF THE INVENTION

1. Field of the Invention

The present invention relates to a method of driving a plasma display panel, and more particularly, to a method of driving subfields in a plasma display panel.

2. Description of the Related Art

Plasma displays having a plasma display panel (PDP), which have replaced conventional cathode ray tube (CRT) display devices, display desired images using visible rays generated by exciting phosphors in a predetermined pattern. The phosphors are excited using vacuum ultraviolet rays generated in a discharge gas by applying a discharge voltage between a plurality of electrodes formed on two substrates that are sealed together. The plurality of electrodes generally include scan electrodes extending in one direction, and address electrodes extending to cross the scan electrodes. A plurality of discharge cells are formed to correspond to regions where scan electrodes and address electrodes cross each other.

An address display separation (ADS) method of driving a plasma display panel divides each of a plurality of frames for displaying a moving image into a plurality of subfields. Each subfield is divided into a reset period for initializing all the discharge cells, an address period for selecting the display cells which are to be turned on or off, and a sustain-discharge period for allowing discharge in the discharge cells which have been selected to be turned on in the address period.

The ADS method drives a plasma display panel by controlling each subfield which is divided into a reset period, an address period, and a sustain-discharge period. The lowest grayscale weighted subfield of the plurality of subfields is also divided into a reset period, an address period, and a sustain-discharge period and when driven performs a reset discharge, an address discharge, and a sustain discharge. However, the lowest grayscale weighted subfield also has a high intensity light unit, which causes a reduction in contrast. In other words, light corresponding to the lowest gray level has high intensity, thereby reducing contrast.

### SUMMARY OF THE INVENTION

An exemplary embodiment of the present invention provides a method of driving a plasma display panel that reduces the intensity of a light unit and performs a stable address discharge.

According to an aspect of the present invention, a method of driving a plasma display panel having a plurality of electrodes, is provided. Each frame includes a plurality of subfields, wherein sustain discharges are performed according to respective grayscale weights allocated to the subfields. The method includes: initializing all discharge cells during a reset period of a first subfield having a lowest grayscale weight among the plurality of subfields; selecting first discharge cells that are to be turned on during an address period of the first subfield, wherein the first discharge cells are address discharged during the address period; initializing all discharge cells during a reset period of a second subfield among the plurality of subfields, subsequent to the first subfield; selecting second discharge cells that are to be turned on during an address period of the second subfield; and sustain discharging the second discharge cells according to the respective grayscale weight during a sustain period of the second subfield. A low voltage level of a scan pulse applied to scan electrodes among the plurality of electrodes in the address periods is lower than a low voltage level of a sustain pulse applied to the scan electrodes in the sustain period.

The low voltage level of the scan pulse may contribute to a discharge start voltage between the scan electrodes and address electrodes among the plurality of electrodes, the address electrodes crossing the scan electrodes.

The low voltage level of the scan pulse may be lower than a lowest voltage level of a reset pulse of the second subfield.

A highest voltage level of a reset pulse of the second subfield may be lower than a high voltage level of a reset pulse of the first subfield.

The reset pulse of the first subfield and the reset pulse of the second subfield each may include a rising pulse and a falling pulse.

The rising pulse and the falling pulse may include ramp pulses.

A bias voltage may be applied to sustain electrodes among the plurality of electrodes when the falling pulse is applied, the sustain electrodes being parallel to the scan electrodes.

In the address period, an address pulse may be applied to address electrodes among the plurality of electrodes to correspond to the scan pulse, the address electrodes crossing the scan electrodes.

An absolute value of the low voltage level of the scan pulse may be greater than an absolute value of a high voltage level of the sustain pulse.

A low voltage level of the sustain pulse may have an opposite polarity to a high voltage level of the sustain pulse.

The low voltage level of the sustain pulse may have substantially the same absolute value as the high voltage level of the sustain pulse.

### BRIEF DESCRIPTION OF THE DRAWINGS

The above and other features and aspects of the present invention will become more apparent by describing in detail exemplary embodiments thereof with reference to the attached drawings in which:

FIG. 1 is a perspective view of a plasma display panel driven using a plasma display panel driving method according to an embodiment of the present invention;

FIG. 2 is a schematic diagram of the arrangement of electrodes of the plasma display panel illustrated in FIG. 1;

FIG. 3 is a block diagram of a plasma display including an apparatus for driving a plasma display panel, such as the plasma display panel illustrated in FIG. 1, using the plasma display panel driving method according to an embodiment of the present invention;

FIG. 4 is a timing diagram of driving signals output from the apparatus for driving the plasma display panel illustrated in FIG. 3 using the plasma display panel driving method according to an embodiment of the present invention;

FIG. 5 is a timing diagram of a plasma display panel driving method according to another embodiment of the present invention; and

FIG. 6 is a graph showing a relationship between a low level Vscl of a scan pulse and discharge delay time Ts of an address discharge.

### DETAILED DESCRIPTION

The present invention will now be described more fully with reference to the accompanying drawings, in which exemplary embodiments of the invention are shown.

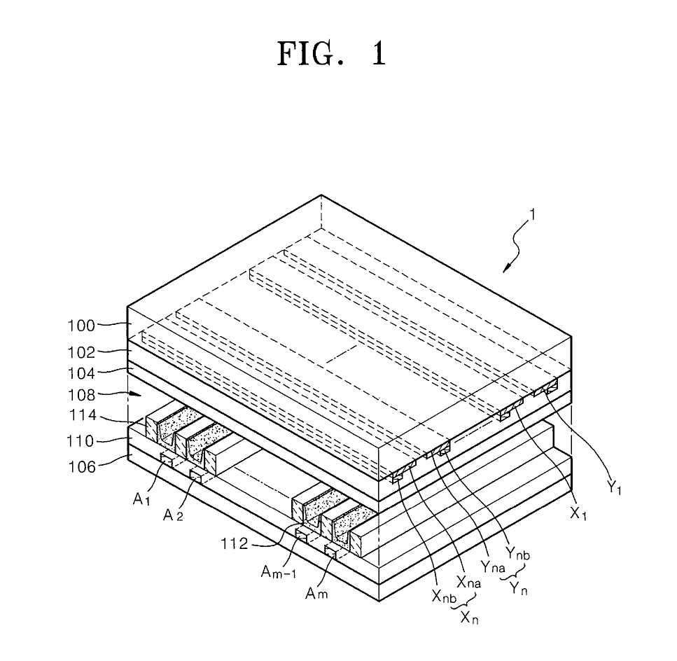

FIG. 1 is a perspective view of a plasma display panel 1 driven using a plasma display panel driving method according to an embodiment of the present invention.

Referring to FIG. 1, address electrodes A₁, . . . , Aₘ, first and second dielectric layers 102 and 110, scan electrodes Y₁, . . . , Yₙ, sustain electrodes X₁, . . . , Xₙ, phosphor layers 112, barrier ribs 114, and an MgO protection layer 104 are formed between first and second substrates 100 and 106 of the plasma display panel 1.

The address electrodes A₁, . . . , Aₘ are formed in a predetermined pattern on the second substrate 106 facing the first substrate 100. The second dielectric layer 110 completely covers the address electrodes A₁, . . . , Aₘ. The barrier ribs 114 are formed parallel to the address electrodes A₁, . . . , Aₘ on the second dielectric layer 110. The barrier ribs 114 define a discharge area of each of a plurality of discharge cells and prevent cross talk between the discharge cells. Each phosphor layer 112 is formed on inner sides of a pair of barrier ribs 114 and the portion of the second dielectric layer 110 located between the pair of barrier ribs, each phosphor layer 112 corresponding to one of the address electrodes A₁, . . . , Aₘ. Each phosphor layer 112 is a red light emitting phosphor layer, a green light emitting phosphor layer, or a blue light emitting phosphor layer.

The sustain electrodes X₁, . . . , Xₙ and the scan electrodes Y₁, . . . , Yₙ are formed in a predetermined pattern on the first substrate 100 facing the second substrate 106 such that they cross the address electrodes A₁, . . . , Aₘ. Discharge cells are defined at the regions where the sustain electrodes X₁, . . . , Xₙ and the scan electrodes Y₁, . . . , Yₙ cross the address electrodes A₁, . . . , Aₘ. Each of the sustain electrodes X₁, . . . , Xₙ and each of the scan electrodes Y₁, . . . , Yₙ are formed by coupling a transparent conductive electrode formed of a material such as Indium Tin Oxide (ITO) with a metal electrode for increasing conductivity. The first dielectric layer 102 is formed to cover the sustain electrodes X₁, . . . , Xₙ and the scan electrodes Y₁, . . . , Yₙ. To protect the plasma display panel 1 from a strong electric field, the protective layer 104, e.g., an MgO layer, is formed to cover the first dielectric layer 102. A gas for forming plasma is sealed in a discharge space 108.

The plasma display panel 1 driven using the plasma display panel driving method according to embodiments of the present invention is not limited thereto. By way of example, the plasma display panel 1 can be a 3-electrode type plasma display panel illustrated in FIG. 1 or a 2-electrode type plasma display panel comprising two electrodes, and can have a variety of structures.

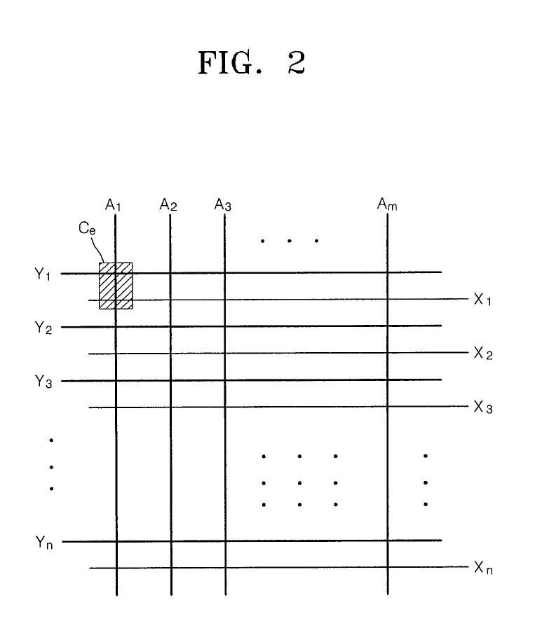

FIG. 2 is a schematic diagram of the arrangement of electrodes of the plasma display panel 1 illustrated in FIG. 1.

Referring to FIG. 2, the scan electrodes Y₁, . . . , Yₙ and the sustain electrodes X₁, . . . , Xₙ are parallel to each other. The address electrodes A₁, . . . , Aₘ cross the scan electrodes Y₁, . . . , Yₙ and the sustain electrodes X₁, . . . , Xₙ.

Discharge cells Ce are defined where the sustain electrodes X₁, . . . Xₙ and the scan electrodes Y₁, . . . , Yₙ cross the address electrodes A₁, . . . , Aₘ.

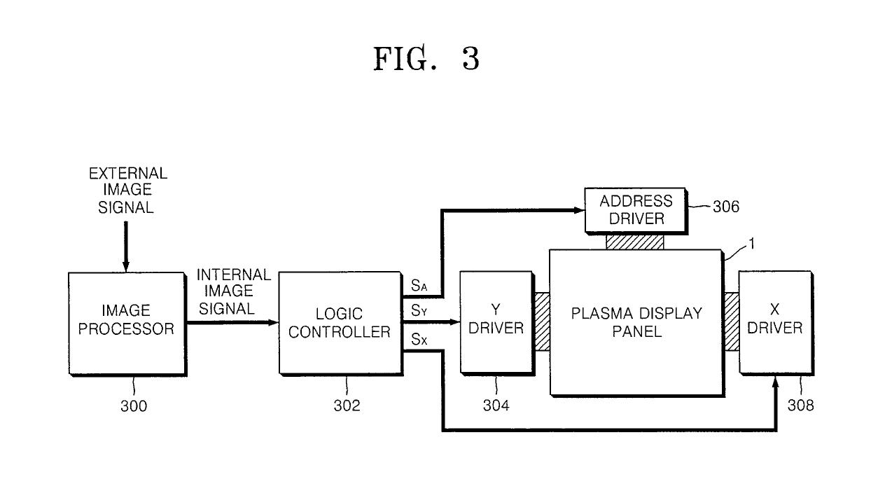

FIG. 3 is a block diagram of a plasma display including an apparatus for driving a plasma display panel, such as the plasma display panel 1 illustrated in FIG. 1, using the plasma display panel driving method according to an embodiment of the present invention.

Referring to FIG. 3, the apparatus for driving the plasma display panel 1 includes an image processor 300, a logic controller 302, a Y driver 304, an address driver 306, and an X driver 308. The image processor 300 converts external image signals into internal image signals. The logic controller 302 receives internal image signals and generates an address driving control signal S_{A}, a scan driving control signal S_{Y}, and a sustain driving control signal S_{X}. The Y driver 304, the address driver 306, and the X driver 308 respectively receive the driving control signals S_{Y}, S_{A}, and S_{X}, and outputs the appropriate driving signals to the scan electrodes Y₁, . . . , Yₙ, the address electrodes A₁, . . . , Aₘ, and the sustain electrodes X₁, . . . , Xₙ Of the plasma display panel 1.

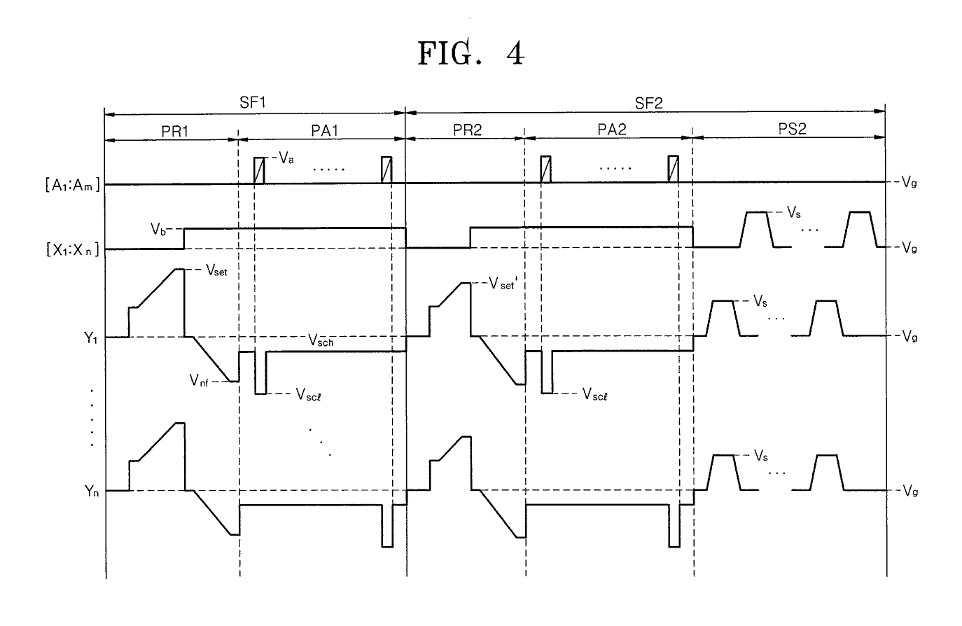

FIG. 4 is a timing diagram of driving signals output from the apparatus for driving the plasma display panel illustrated in FIG. 3 using the plasma display panel driving method according to an embodiment of the present invention.

Referring to FIG. 4, a first subfield SF1 has the lowest grayscale weight, and a second subfield SF2 is subsequent to the first subfield SF1. The first subfield SF1 having the lowest grayscale weight can be any one of a plurality of subfields.

The first subfield SF1 is divided into a reset period PR1 and an address period PA1. The second subfield SF2 is divided into a reset period PR2, an address period PA2, and a sustain period PS2. To reduce an intensity of light unit (i.e., intensity of light corresponding to the lowest gray level) of the first subfield SF1 having the lowest grayscale weight, the first subfield SF1 does not include a sustain period. A conventional subfield having the lowest grayscale weight has a sustain period to emit sustain light by a sustain discharge as well as a reset period and an address period. However, the first subfield SF1 having the lowest grayscale weight in the described embodiment of the present invention has the reset period and the address period in which emitted light includes reset light and address light generated by a reset discharge and an address discharge, respectively, but does not have a sustain period. Therefore, the intensity of the light unit is reduced by using the first subfield SF1 of the plasma display panel driving method according to the described embodiment of the present invention compared to conventional driving methods. This way, the contrast of the display is improved. The second subfield SF2 has a reset period PR2, an address period PA2, and a sustain period PS2.

In the reset periods PR1 and PR2 in which all discharge cells are initialized, a reset pulse having a rising pulse and a falling pulse are applied to the scan electrodes Y₁, . . . , Yₙ. The rising pulse and the falling pulse can be in the form of ramp pulses as illustrated in FIG. 4. When the falling pulse is applied, a positive bias voltage Vb is applied to the sustain electrodes X₁, . . . , Xₙ parallel to the scan electrodes Y₁, . . . , Yₙ. The application of the rising pulse leads to a weak discharge in discharge cells so that wall charges are accumulated in discharge cells. The application of the falling pulse and the bias voltage Vb leads to a weak discharge in discharge cells and wall charges accumulated in discharge cells are removed.

In the embodiment depicted in FIG. 4, a highest voltage Vset′ of the reset pulse of the second subfield SF2 is lower than a highest voltage Vset of the reset pulse of the first subfield SF1. The first subfield SF1 does not perform a sustain discharge but only an address discharge in the address period PA1. Therefore, the driving apparatus does not have to apply as high a voltage in the second subfield SF2 subsequent to the first subfield SF1, as the reset pulse of the first subfield SF1. Although the highest voltage Vset′ of the reset pulse of the second subfield SF2 is lower than the highest voltage Vset of the reset pulse of the first subfield SF1, discharge cells are initialized.

In the address periods PA1 and PA2 in which discharge cells that are to be turned on are selected, scan pulses are applied to the scan electrodes Y₁, . . . , Yₙ corresponding to the discharge cells that are to be turned on. Address pulses are applied to the address electrodes A₁, . . . , Aₘ corresponding to the scan pulses. The scan pulses and the address pulses lead to the selection of discharge cells that are to be turned on. The address discharge occurs due to the potential difference between the address electrodes A₁, . . . , Aₘ and the scan electrodes Y₁, . . . , Yₙ of the selected discharge cells.

In the embodiment depicted in FIG. 4, a low voltage level Vscl of the scan pulses is lower than that of a lowest voltage level Vnf of the reset pulses. More wall charges are accumulated in discharge cells after the lowest level Vnf of the reset pulse is applied than when the low level Vscl of the scan pulses is applied in order to stably perform the address discharge

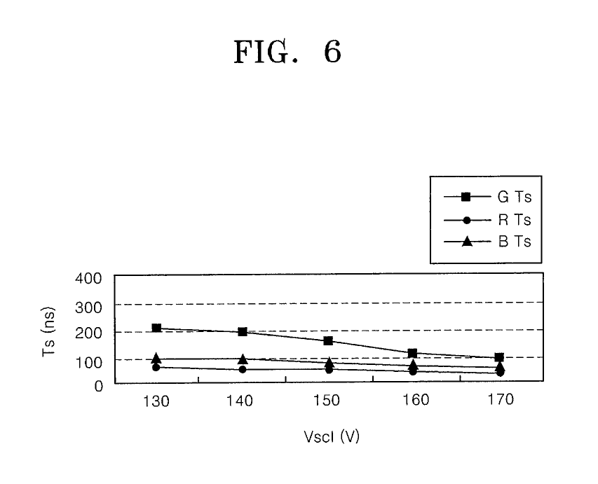

In the embodiment depicted in FIG. 4, a low voltage level Vscl of the scan pulses applied to the scan electrodes Y₁, . . . , Yₙ in the address periods PA1 and PA2 is lower than that of a low level Vg of a sustain pulse. Further, the magnitude of the low voltage level Vscl of the scan pulses is greater than that of a high voltage level Vs of the sustain pulse in order to perform the address discharge when a small amount of wall charges are accumulated in the discharge cells in the reset periods PR1 and PR2 due to the reduction of the low voltage level Vscl of the scan pulses, that is, in order to reduce a probability of an address discharge failure since the highest voltage level Vset′ of the reset pulses in the reset period PR2 of the second subfield SF2 is lower than the highest voltage level Vset of the reset pulses in the reset period PR1 of the first subfield SF1. Also, assuming that no wall charges remain in discharge cells when the reset period PR2 of the second subfield SF2 terminates, the low voltage level Vscl of the scan pulses can be a discharge start voltage between the address electrodes and the scan electrodes. The relationship between the low voltage level Vscl of the scan pulses and the address discharge will be described later with reference to FIG. 6.

In the sustain period PS2 in which a sustain discharge is performed in the discharge cells that are selected to be turned on in the address period PA2 by the number corresponding to allocated grayscale weights, a scan pulse alternately having a high voltage level Vs and a low voltage level Vg is alternately applied to the scan electrodes Y₁, . . . , Yₙ and the sustain electrodes X₁, . . . , Xₙ. The application of the sustain pulse leads to the sustain discharge in the discharge cells (in which an address discharge was performed) selected in the address period PA2.

The sustain period PS2 is not included in the first subfield SF1 but is included in the second subfield SF2 in order to reduce the intensity of a light unit relating to the plasma display panel driving method of the present invention.

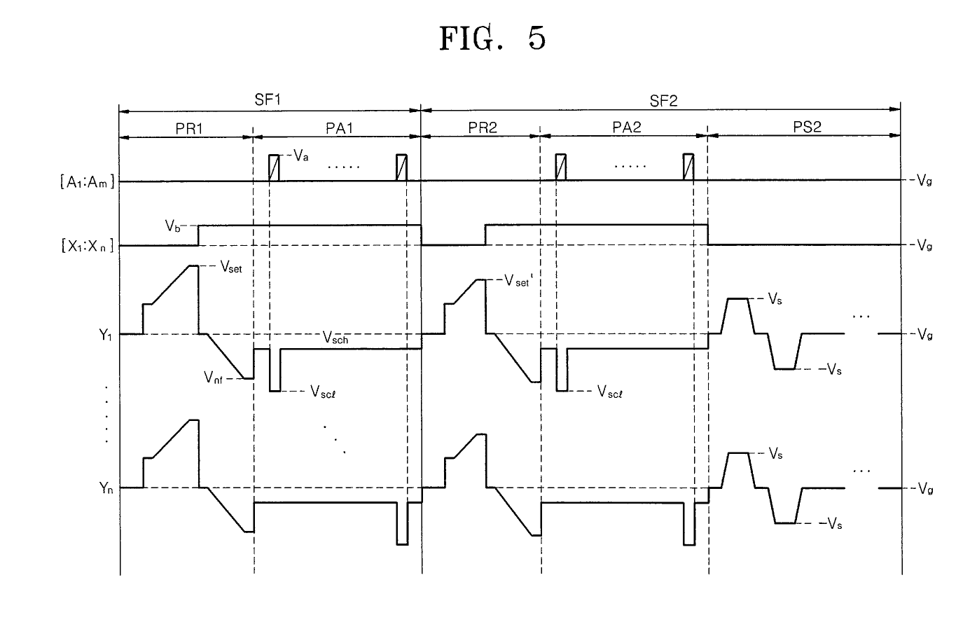

FIG. 5 is a timing diagram of a plasma display panel driving method according to another embodiment of the present invention.

Referring to FIG. 5, a first subfield SF1 has a lowest grayscale weight, and a second subfield SF2 is subsequent to the first subfield SF1. The first subfield SF1 can be any one of a plurality of subfields.

The first subfield SF1 is divided into a reset period PR1 and an address period PA1. The second subfield SF2 is divided into a reset period PR2, an address period PA2, and a sustain period PS2.

Driving signals applied to the reset period PR1 and the address period PA1 of the first subfield SF1 and the reset period PR2 and the address period PA2 are substantially the same as those in the previous embodiment illustrated in FIG. 4, and thus their description will be omitted.

In the sustain period PS2 of the second subfield SF2, a sustain pulse having a high voltage level Vs and a low voltage level −Vs is applied to the scan electrodes Y₁, . . . , Yₙ, and a ground voltage Vg is applied to the sustain electrodes X₁, . . . , Xₙ. In detail, the high voltage level Vs and the low voltage level −Vs of the sustain pulse have the same magnitude and opposite polarity. The application of the high voltage level Vs of the sustain pulse leads to a sustain discharge so that negative wall charges are accumulated around the scan electrodes and positive wall charges are accumulated around the sustain electrodes. The application of the low voltage level −Vs of the sustain pulse leads to the sustain discharge so that positive wall charges are accumulated around the scan electrodes and negative wall charges are accumulated around the sustain electrodes.

With reference to the plasma display panel driving method of the present invention, the low voltage level Vscl of the scan pulse may be lower than the low voltage level −Vs of the sustain pulse in order to perform an address discharge.

FIG. 6 is a graph showing the relationship between a low voltage level Vscl of a scan pulse and discharge delay time Ts of an address discharge.

The address discharge occurs by applying the scan pulse to scan electrodes and applying an address pulse to address electrodes. In particular, the address discharge occurs due to an electric potential difference between the low voltage level Vscl of the scan pulse and a high voltage level Va of the address pulse, and wall charges accumulated in discharge cells when a reset period terminates.

Referring to FIG. 6, as the low voltage level Vscl of the scan pulse decreases, discharge delay time R Ts of a red discharge cell coated by a red phosphor, discharge delay time G Ts of a green discharge cell coated by a green phosphor, and discharge delay time B Ts of a blue discharge cell coated by a blue phosphor are reduced. When an electric field of the low level Vscl of the scan pulse is about −150 volts, the discharge delay time Ts of the address discharge is significantly reduced. The discharge delay time Ts of the address discharge may be less than 100 nsec. A high voltage level Vs of the scan pulse is approximately 170 volts. Therefore, the electric field of the low voltage level Vscl of the scan pulse may be greater than that of the high voltage level Vs of the sustain pulse.

The lower the electric potential of the low voltage level Vscl of the scan pulse is, the more the discharge delay time Ts of the address discharge is reduced, thereby obtaining a stable discharge.

The described embodiments of the present invention include the following features and aspects:

A first subfield having a lowest grayscale weight does not include a sustain period, a highest voltage level of a reset pulse of a second subfield subsequent to the first subfield is lower than a highest voltage level of a reset pulse of the first subfield, and a low voltage level of a scan pulse is lower than a low voltage level of a reset pulse, thereby reducing the intensity of a light unit and discharge delay time of an address discharge so that the address discharge is stably performed.

While the present invention has been particularly shown and described with reference to exemplary embodiments thereof, it will be understood by those of ordinary skill in the art that various changes in form and details may be made therein without departing from the spirit and scope of the present invention as defined by the following claims and equivalents thereof.

What is claimed is:

1. A method of driving a plasma display panel comprising a plurality of electrodes, in which each frame includes a plurality of subfields, wherein sustain discharges are performed according to respective grayscale weights allocated to the subfields, the method comprising:
initializing all discharge cells during a reset period of a first subfield having a lowest grayscale weight among the plurality of subfields;
selecting first discharge cells that are to be turned on during an address period of the first subfield, wherein the first discharge cells are address discharged during the address period;
initializing all discharge cells during a reset period of a second subfield among the plurality of subfields, subsequent to the first subfield;
selecting second discharge cells that are to be turned on during an address period of the second subfield; and
sustain discharging the second discharge cells according to the respective grayscale weight during a sustain period of the second subfield,
wherein a low voltage level of a scan pulse applied to scan electrodes among the plurality of electrodes in the address periods is lower than a low voltage level of a sustain pulse applied to the scan electrodes in the sustain period.

2. The method of claim 1, wherein the low voltage level of the scan pulse contributes to a discharge start voltage between the scan electrodes and address electrodes among the plurality of electrodes, the address electrodes crossing the scan electrodes.

3. The method of claim 1, wherein the low voltage level of the scan pulse is lower than a lowest voltage level of a reset pulse applied to the scan electrodes during the second subfield.

4. The method of claim 1, wherein a highest voltage level of a reset pulse applied to the scan electrodes during the second subfield is lower than a high voltage level of a reset pulse applied to the scan electrodes during the first subfield.

5. The method of claim 4, wherein the reset pulse of the first subfield and the reset pulse of the second subfield each include a rising pulse and a falling pulse.

6. The method of claim 5, wherein the rising pulse and the falling pulse comprise ramp pulses.

7. The method of claim 5, wherein a bias voltage is applied to sustain electrodes among the plurality of electrodes when the falling pulse is applied, the sustain electrodes being parallel to the scan electrodes.

8. The method of claim 5, wherein, in the address period, an address pulse is applied to address electrodes among the plurality of electrodes to correspond to the scan pulse, the address electrodes crossing the scan electrodes.

9. The method of claim 1, wherein an absolute value of the low voltage level of the scan pulse is greater than an absolute value of a high voltage level of the sustain pulse.

10. The method of claim 1, wherein the low voltage level of the sustain pulse has an opposite polarity to a high voltage level of the sustain pulse.

11. The method of claim 10, wherein the low voltage level of the sustain pulse has substantially the same absolute value as the high voltage level of the sustain pulse.
